(19) United States
(12) Patent Application Publication
(10) Pub. No.: US 2009/0003387 A1
(43) Pub. Date: Jan. 1, 2009

(54) Synchronization Between Connection Manager and Extension Components

(75) Inventors: Ara Bernardi, Mercer Island, WA (US); Huei Chung Wang, Kirkland, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/769,554

(22) Filed: Jun. 27, 2007

(51) Int. Cl. H04J 3/06

(52) U.S. Cl. 370/503

(57) ABSTRACT

This disclosure describes synchronization between a connection manager and extension components during terminal service starts, stops, and restarts. The synchronization occurs by application programming interfaces as mechanisms to notify extension components that a change of state is about to occur. The extension components take appropriate action steps, such as saving session information for a connection pertaining to a connection stop and restoring connection session information when the terminal service is restarted. Furthermore, the extension components may implement own caching mechanisms and selectively perform lazy restore on save data as necessary. As a result, experience for the user is enhanced by not losing any data when the terminal service is stopped and restarted. Also, administrators may perform a patch on terminal service binaries without waiting for all users to log off or without rebooting the system.

### TECHNICAL FIELD

The subject matter relates generally to terminal services, and more specifically, to synchronizing session information between a connection manager and extension components during service start and shutdown.

### BACKGROUND

Terminal Service (TS) is a product offered by Microsoft® Corporation, which allows multiple users operating computing devices to connect simultaneously to a remote host computer over a network. The TS provides a conduit for input and output between the users and the remote host computer.

Multiple users may run applications on the remote host computer, access files, databases, network resources, and the like, that are stored on the remote host computer. However, users in TS may often encounter problems, such as performance problems, service disruptions, and the like. User-perceptible and annoying stops and restarts are rampant, which cause frustrations for users. For example, users may lose their existing work during service stops and restarts on TS. As a result, users in TS are often inconvenienced due to the service disruptions, which can be very time consuming and unproductive.

To further illustrate the problems of stopping services on TS, users are notified to log off TS at a certain time and the administrator waits for all users to log off TS before performing a patch or a service pack. Thus, existing protocols are inadequate in saving connection type information to assist in shutdowns and restarts. As a result, users lose data and become dissatisfied with TS. Thus, the stops and the restarts in TS have not provided a satisfying user experience.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In view of the above, this disclosure describes various exemplary systems, methods, and application programming interfaces for synchronizing session information between a connection manager and extension components during starts, shutdowns, and restarts in terminal services (TS). The application programming interfaces (APIs) are mechanisms that notify the extension components of a change of state about to occur, such as service start, shutdown, and restart in terminal services. The extension components save session information for a connection stop or a disconnection and save data before the service stops. Furthermore, the extension components restore connection specific session information upon restarting the terminal service. Service stops and/or disconnections may be defined as a desired course of transmission did not occur during a remote terminal session with TS.

This disclosure provides issuing a notification of the change of state from running to stopping service from a remote connection manager to WinStation Extension (WSX) components. As a result, the computing devices that are “active”, such as connected to the TS, will also receive this notification. This disclosure describes the WSX extension components employ a caching mechanism which may include a simple file system, another process in the same computer, or a central service residing on a network.

This synchronization of session information between the connection manager and the extension components improves the efficiency and convenience of starts, stops, and restarts on terminal services for users on computing devices. In particular, the users will not lose any data during stops and restarts in the terminal services. Thus, reliability is improved and the user experience is enhanced.

### BRIEF DESCRIPTION OF THE DRAWINGS

The Detailed Description is set forth with reference to the accompanying figures. The teachings are described with reference to the accompanying figures. In the figures, the left-most digit(s) of a reference number identifies the figure in which the reference number first appears. The use of the same reference numbers in different figures indicates similar or identical items.

FIG. 1 is a block diagram of an exemplary terminal services environment for synchronization of session information.

FIG. 2 is a block diagram of an exemplary terminal services synchronization system of FIG. 1.

FIG. 3 is a block diagram of an exemplary process illustrating the change of states of the system of FIG. 2.

FIG. 4 is a schematic block diagram of an exemplary remote connection manager service start.

FIG. 5 is a schematic block diagram of an exemplary remote connection manager service stop.

FIG. 6 is a schematic block diagram showing an exemplary processing functionality of the system of FIG. 2.

### DETAILED DESCRIPTION

### Overview

This disclosure is directed to terminal service (TS), and is shown and described in the context of synchronizing session information between a remote connection manager and extension components before the change of states are completed. The change of states include a change from not active to running, a change from running to stopping, and a change from running to stopping to restarting, such as starts, stops, and restarts, respectively, in TS. Advantages of using TS include facilitate sharing of technologies, administering an application that is maintained or upgraded at one central location, and providing a user interface including operating system desktop and support for a variety of input devices. This disclosure describes enhancing the user experience on TS through protocols, application programming interfaces, servers, and system responses.

This disclosure describes synchronization by deploying application programming interfaces (APIs) as mechanisms to notify the extension components of the change of state that is about to happen and enabling the extension components to take appropriate action. The extension components or WinStation (WSX) protocol extensions can save session information for a connection or a session before the TS shuts down. The APIs enable the extension components to take action such as restoring connection specific session information during starts and restarts in TS. A benefit to the users is the stopping and the restarting of TS will not cause current or existing data on the computing devices to be lost. Thus, the users may resume an application once the connection is reestablished.

In one aspect, an algorithm, known as a remote connection manager (RCM) service start, commences a local session manager and RCM. The RCM service start algorithm calls the APIs of a local session manager to retrieve a session unique identifier and any stored extension dynamically linked library (DLL). The algorithm includes loading and initializing the extension components, caching the session information along with a session, constructing a state diagram for initializing the session transactions for an application that is accessed on TS. If the restore fails, the algorithm causes the session to log off.

In another aspect, a RCM service stop algorithm stops the sessions. The RCM service stop algorithm stops all listeners for all of the extension components providers and disconnects all sessions. The algorithm stops servicing remote procedure call (RPC) requests. Next, the algorithm includes calling a signal protocol extension component that RCM is changing of state from active to stopping. Thus, synchronization occurs by enabling the extension components to save and to update any global state, such as private state or session information. Furthermore, the APIs enable the extension components to cache connection session information and connection's associated session. When the service changes from running to stop, the users do not have to log off when an administrator performs patching on TS binaries or extension components. Thus, the user experience is enhanced without having to log off and log back on to TS.

The synchronization described herein are not limited to any particular application, but may be applied to many contexts and environments. By way of example and not limitation, the synchronization may be employed in Windows Server System™, Windows Server® Longhorn, Windows Vista™, centralized computing services, and the like. For example, remote desktop protocol (RDP) allows users with computing devices to establish a remote terminal session with a remote host server by way of a remote desktop connection (RDC), a Terminal Services Client (TSC), and the like. Alternatively, a protocol that may be used between the client computing and a server is Independent Computing Architecture Protocol (ICA).

### Exemplary Terminal Services Environment

The following discussion of an exemplary operating environment provides the reader with assistance in understanding one way in which various subject matter aspects of the system, methods, and application programming interfaces may be employed. The environment described below constitutes but one example and is not intended to limit application of the subject matter to any one particular operating environment.

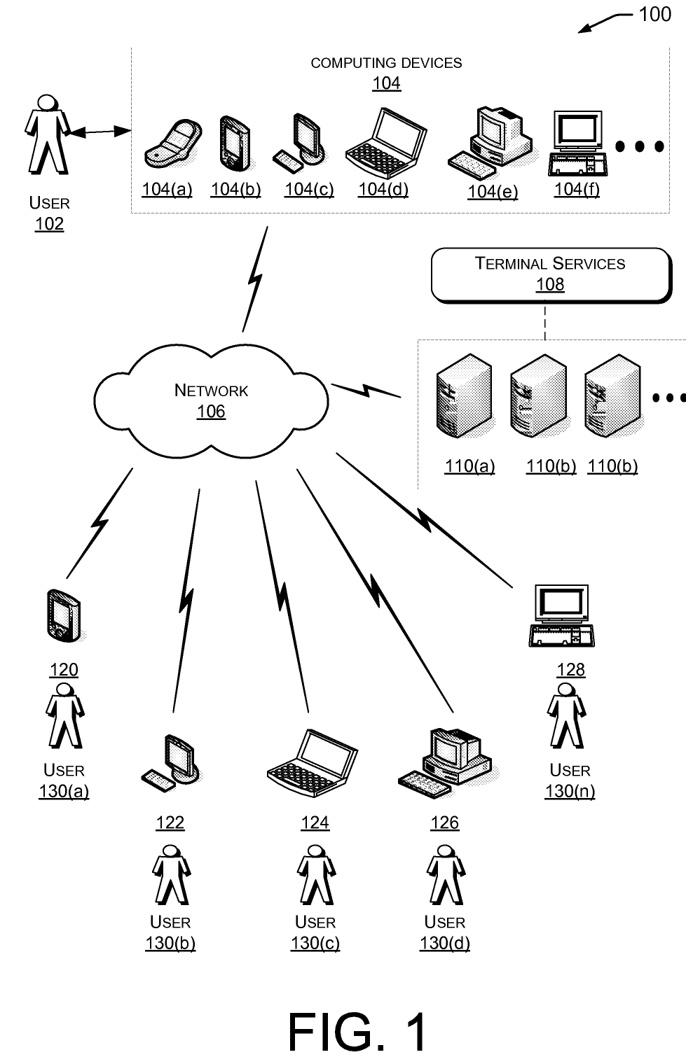

FIG. 1 is an overview block diagram of an exemplary terminal service environment 100 for providing TS. A user 102 with computing devices 104 may connect to a network 106 to establish a remote terminal session using TS 108.

Computing device(s) 104 that are suitable for use, include but are not limited to, a cellular phone 104(a), a personal digital assistant 104(b), a personal computer 104(c), a laptop computer 104(d), a desktop computer 104(e), a workstation 104(f), and the like. These various types of computing devices 104 in operation with TS 108 enable the user 102 to conduct an activity, such as running applications, accessing files, databases, network resources, shared folders, and the like.

The network 106 providing access to TS 108, includes any kind of digital network, an intranet, Digital Subscriber Line (DSL) network infrastructure, point-to-point coupling infrastructure, and the like. The network 106 may be defined as hardware, software, and media connecting information technology resources. Typically, the network 106 connects clients, servers, a number of other components like routers, switches, and the like through a communication media. The network 106 can include various hardwired and/or wireless links, routers, gateways, name servers, and the like. The network 106 is governed by any protocol or combination of protocols, such as Internet Protocol (IP), Transmission Control Protocol (TCP), Hypertext Transfer Protocol (HTTP), and the like.

TS 108 provides functionality to allow several computing devices 104 to connect to a centralized remote host. A user 102 can log on at a terminal, and run applications, access data, databases, network resources, and the like through TS 108. Each log in or terminal session is independent. Advantages of using TS 108 include facilitate sharing of technologies, administering an application that is maintained or upgraded at one central location, and providing a complete graphical user interface including operating system desktop and support for a variety of input devices. TS 108 offers the convenience of storing applications on a single server 110 that is available to users 102 located anywhere in the world.

The components operating TS 108 are configured to function on a server 110. The term, “server” is used interchangeably with the term, a “remote host computer” 110, which provides physical and virtual resources. The operating environment 100 may comprise a single terminal server 110(a) or multiple servers 110(b) . . . 110(n) deployed as separate servers within a server farm. For example, the remote host computer 110 may include a terminal server 110(a), a remote computer 110(b), a server for load balancing, a server for managing the system, a server for database, a server for applications, and the like. Also, a terminal server gateway may be included to enable authorized users to connect to one or more remote host computers 110 on a corporate network. In an exemplary implementation, there may be one server, the remote host computer 110, to perform the described functions.

The remote host computer 110 provides applications, files, databases, network resources, and the like that are stored on the host computer 110. The remote host computer 110 may provide a complete graphic user interface including a Microsoft Windows™ operating system desktop and support a variety of input devices, such as a keyboard or a mouse. The applications run entirely on the remote host computer 110.

The remote host computer 110 in operation with TS 108 provides users with computing devices access to the remote terminal sessions over the network 106. For example, computing devices of other individuals, may include, but are not limited to a personal digital assistant 120, a personal computer 122, a laptop computer 124, a desktop computer 126, a workstation 128, and the like. These computing devices may be associated with individuals, known as a user 130(a), 130(b), 130(c) . . . 130(n).

In an implementation, these users 130(a) . . . 130(n) may be associated with each other as part of a corporation, a business, an education facility, a government association, a distributed computing environment, a hospital, and the like. In another implementation, these users 130(a) . . . 130(n) may be separate individuals where each individual is a part of the corporation, the distributed computing environment, the business, the education facility, the government association, and the like.

### Exemplary Terminal Services System

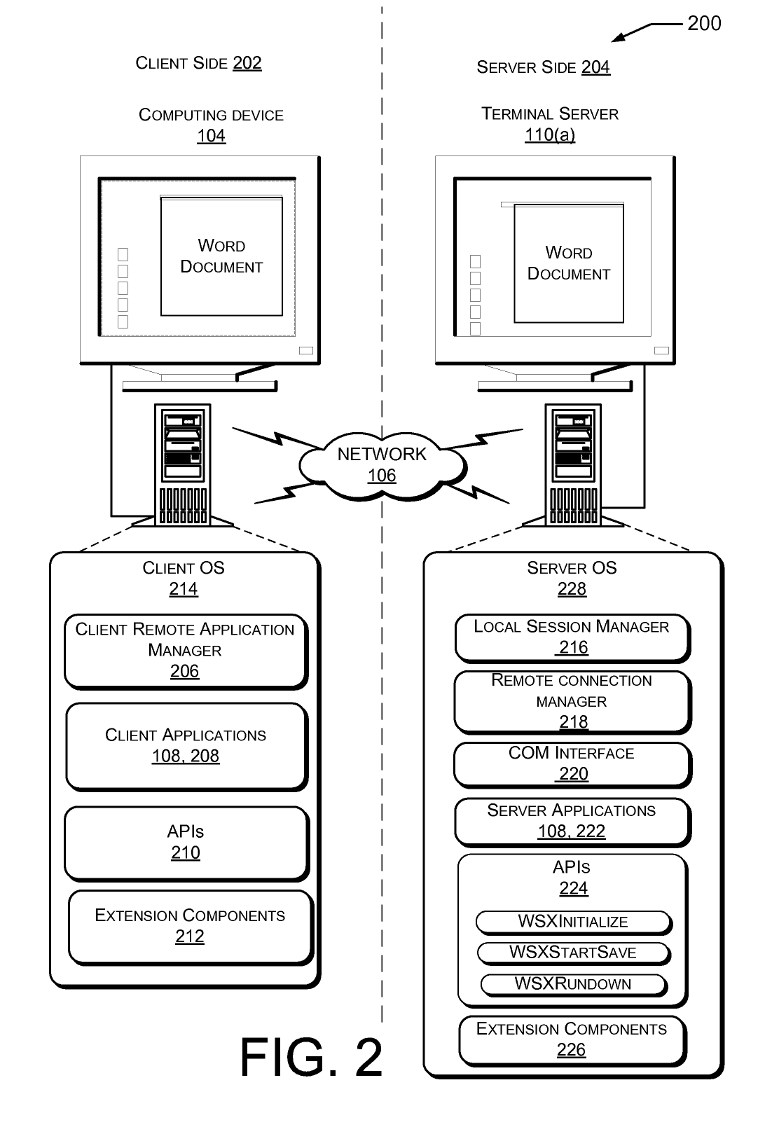

Illustrated in FIG. 2 is an exemplary system 200 configured to synchronize session information during stops and starts in the remote terminal session between the client computing device 104 and the terminal server 110(a) over a network 106. The system 200 illustrates architecture of some components on a client side 202 and a server side 204. Alternatively, these components may reside in multiple other locations. For instance, all of the components of FIG. 2 may exist on the client side 202 or the server side 204. Furthermore, two or more of the illustrated components may combine to form a single component at a single location.

The client side 202 includes the client computing device 104 to access TS 108 on the system 200. The computing device 104 includes a client remote application manager 206, one or more client applications 108, 208, extension components 210, APIs 211 operating on a client operating system 212.

The client remote application manager 206 is configured to establish the remote terminal session with the terminal server 110(a). The client remote application manager is configured to handle interconnections with the terminal server 110(a) related to TS. The client remote application manager 206 is also configured to respond to user commands for applications 108, 208 on the terminal server 110(a).

The one or more applications 208 include terminal services 108, word processing applications, spreadsheet applications, graphics applications, databases, file browser tools, and the like.

The client computing device 104 includes APIs 210 to support requests for services to be made of it by a computer program. The API 210 may include a coherent interface consisting of several sets of related functions or procedures or a single entry point such as a method, a function, or a procedure. An example of an API is Microsoft Windows API.

The extension components 212 receive notification of a future change of state from the APIs and take action upon receiving this information from the APIs.

The client operating system 214 includes but is not limited to, Windows Server System™, Windows Server® Longhorn, Windows Vista™, and the like.

In an implementation, the client remote application manager 206 is configured to establish a remote desktop web connection function, where the computing device 104 on the client side 202 uses Microsoft® Internet Explorer® and a connection to world wide web to gain access to TS 108 and applications on the terminal server 110(a).

This is advantageous when accessing TS 108 through a public facility, such as the library, an employer's computer, computing devices with limited memory capacity, and the like.

In an exemplary implementation, the client side 202 includes thin-client hardware devices 104 that run an embedded Windows-based operating system, to enable using TS 108 client software to connect to the terminal server 110(a). In another implementation, computing devices 104 with Windows Server System™, Windows Server® Longhorn, Windows Vista™, can run TS client software to connect to the terminal server 110(a) to display Windows-based applications. Thus, these options with TS 108 provide access to Windows-based applications from any operating system.

While FIG. 2 illustrates a display for the remote host computer, one skilled in the art is aware that this is merely an example used to illustrate how the data on a word document is maintained and not lost during shutdowns and restarts of the connection. The server side 204 of the system 200 includes the terminal server 110(a). The terminal server 110(a) includes a local session manager (LSM) 216, a remote connection manager 218, a COM interface 220, one or more server applications 108, 222, APIs 224, and extension components 226 operating on a server operating system (OS) 228.

The role of the local session manager 216 is to create one or more sessions and to manage the sessions, such as connecting the sessions to remote terminals in cooperation with the remote connection manager 218. The LSM 216 provides other management functionality, such as disconnecting from the terminal, reconnecting from the terminal, and APIs to enumerate sessions. In one implementation, the LSM 216 is configured to help manage the multiple computing devices logging onto TS 108 and the multiple number of terminal servers. The LSM is configured to set or get session related data and finally terminate the session. In an exemplary implementation, the LSM 216 may retrieve a session local unique identifier and matching extension component names. The LSM 216 is configured to start and to stop the remote connection manager 218.

The remote connection manager 218 is configured to facilitate remote terminal session functionality on the server side 204. The RCM 218 sends notifications to the WSX protocol extensions of the change of state. The remote connection manager 218 is configured to manage server applications such that a representation of the server application window can be sent to the client computing devices 104 in the remote terminal session. The server RCM 218 is also configured to facilitate transfer of data related to the server application from the terminal server 110(a) to the client computing device 104. For instance, multiple applications may be running on the terminal server 110(a) while the client computing device 104 only uses one of the applications.

In some implementations, the server RCM 218 is configured to ensure that data from the appropriate application window is sent to the client computing device 104. The server RCM 218 is configured to send the user commands to the client remote application manager 206. Furthermore, the RCM 218 makes a terminal object by working with the WSX protocol extensions. The RCM 218 may be stopped by the LSM 216 or a windows service control manager (SCM).

Shown is a component object model (COM) interface 220. For purposes of discussion, the COM 220 is introduced after discussing the RCM 218, but it may be located between the LSM 216 and the RCM 218. The COM interface 220 is configured to allow the RCM 218 to cache data onto a session object. However, the COM interface 220 is not made public.

The one or more applications 108, 222 include terminal services 108, word processing applications, spreadsheet applications, graphics applications, database applications, and the like.

The APIs 224 are configured to enable synchronization of session information between the RCM 218 and WSX protocol extension components 226 during the change of states, such as starts, shutdowns, and restarts. The APIs 224 are configured to receive information from the RCM 218 and to monitor the sessions or connections. In particular, these windows APIs 224 are configured to perform functions including but not limited to, initializing and calling the extension components; calling the extension components once the RCM 218 is stopping and enabling the extension components to save and to update any global state or session information; and calling the extension components 226 to allow caching connection session information and the associated session of the connection.

In an implementation, the APIs 224 may be entitled WsxWinStationInitialize, WsxWinStationStartSave, and WsxWinStationRundown, for initializing the terminal services and extension components, saving session information upon the change of state from running to stop, and shutting down the session, respectively. These are shown merely as examples in APIs 224 using WSX acronym for WsxWinStation extension.

The extension components (WSX) 226 or alternatively referred to as WSX protocol extensions, are configured to receive notification of a future change of state from the APIs 224 and configured to take action upon receiving this information from the APIs 224.

The server operating system 228 includes but is not limited to, Windows Server System™, Windows Server® Longhorn, Windows Vista™, Linux, and the like. The operating system 228 is configured manage hardware and software resources on the terminal server 110(a). The operating system 228 is configured to form a platform for other system software and for application software.

The network 106 may include the Internet, a Local Area Network (LAN), a Wide Area Network (WAN), a wireless network, business WiFi LANs, home WiFi LANs, public WiFi hotspots, WiMAX wide area networks, cellular technologies, and/or the like. Also, the cellular devices function in either unlicensed wireless or licensed cellular technologies, such as unlicensed IEEE 802.11 wireless networking standard and licensed cellular technology, such as global system for mobile communications (GSM) or code division multiple access (CDMA).

In an exemplary implementation, the user 102 may use the laptop computer 104(d) at home by accessing a WiFi LAN located in his or her home using RDP by way of RDC. The RDC provides access to TS 108 and the applications on the terminal server 110(a). The WiFi LAN may enable the user 102 to access a broadband data service, such as Digital Subscriber Line (DSL) service, satellite Internet service, or cable modem service.

### Exemplary Change of State

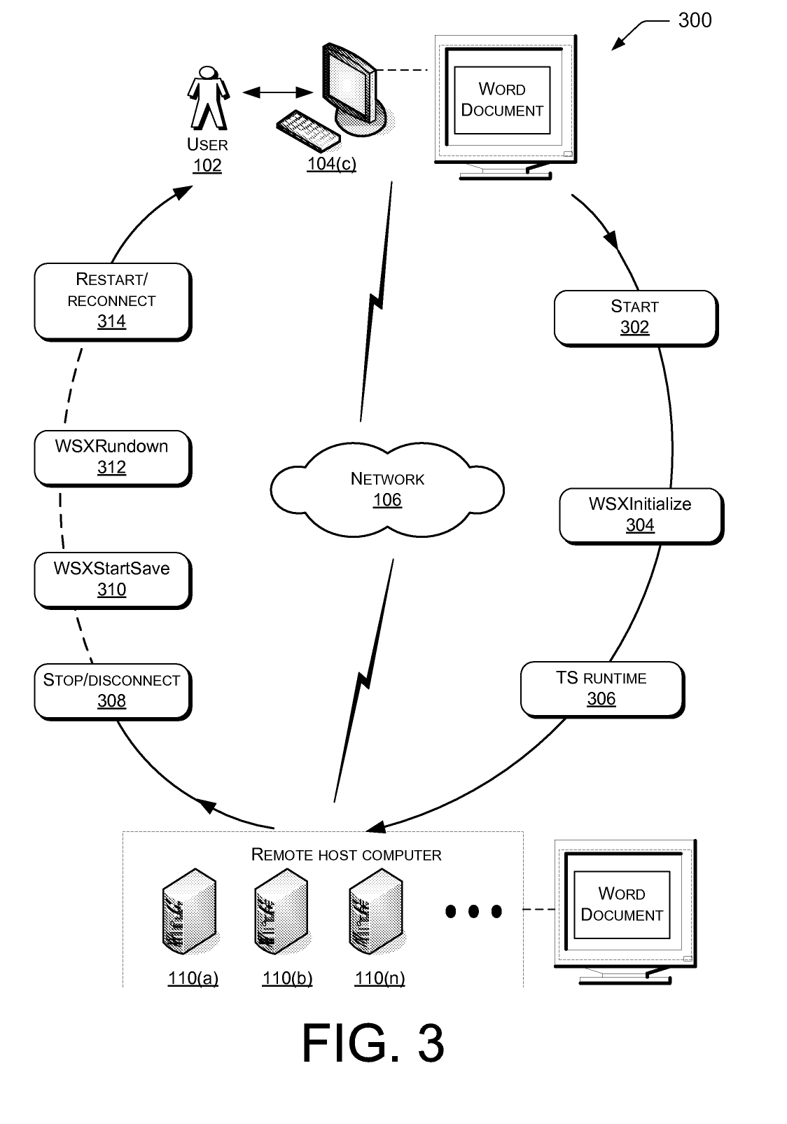

FIG. 3 is a block diagram of an exemplary process illustrating a change of state, such as a start/session, a stop/disconnection, and a restart/reconnection 300 of the system of FIG. 2. For ease of understanding, the method 300 is delineated as separate steps. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible that one or more of the provided steps may be omitted.

Traditionally, shutting down and restarting TS 108 have been challenging. The shutdowns tend to cause the users to lose data, if not saved. While some versions allow the administrator to perform patching without a system reboot, the information cached by extension components for the connection tends to be lost upon stopping and unloading TS 108.

For illustration purposes, the solid lines extending from the user 102 and the computing device 104(c) indicate signing in or logging on to TS 108 to call the LSM 216. The user 102 signs in with the client computing device 104 to create a session through the LSM 216. The session begins by sending a request over the network 106 to the LSM 216. The terms session and connect are used interchangeably to describe a computing device 104 that connects to the terminal server 110(a) to access TS 108. Also, some protocols are state full, which means creating a session for a particular client, where some of the data transcends the lifetime of that client computing device 104 tied to the session.

In Start 302, the TS 108 calls the APIs 224 of the LSM 216 to retrieve a session unique identifier (SLUID) and any stored extension dynamically linked library (DLL). This SLUID remains the same for a lifetime of a session. The SLUID comprises information uniquely related to the user 102 and sufficient information to enable the session to later be identified. In an exemplary implementation, the startup phase may take less than ten seconds.

Shown in WSX Initialize 304, TS 108 calls the APIs 224 of the LSM 216 to load the extension components, DLL, if not already loaded and initializes the extension components, DLL, if not initialized yet.

Also, TS 108 calls the right WSX protocol extension restore in SLUID, where WSX protocol extension retrieves and restores the session information, such as hContext packed in a contiguous serialized format. Thus, the APIs 224 serialize and deserialize the session information, hContext. The session information may be serialized in XML. The hContext in the contiguous serialized format is unpacked into the memory space of TS 108. This retrieval occurs at an appropriate time and the restoration occurs very quickly. Extension components WSX 226 returns a pointer to TS 108. Furthermore, TS 108 keeps track of the session information returned, starts listeners for the protocol providers, and starts servicing remote procedure call (RPC) requests.

Shown in 306 is TS runtime, where TS 108 manages a list of the session information, hContext, in memory space of the TS 108 for both active and disconnected sessions.

Shown are the remote host computer(s) 110. As mentioned previously, there may be one or more servers, a terminal server, a database server, a server farm, and the like to provide terminal services 108. For illustrative purposes, a display of the terminal server 110(a) shows a word document created by the user 102. Meanwhile, the client computing device 104(c) has a representation or image of this word document created by the user 102 in an application program, such as Microsoft Word located on the remote host computer 110. For example, the word document on the terminal server 110(a) and on the client computing device 104(c) are representations of one another. In particular, the software programs are stored, maintained, and updated through the remote host computer 110.

Block 308 illustrates dashed lines to show the change of state. The APIs 224 inform the extension components 226 that a change of state is about to occur. This causes the extension components 226 to take a course of action, such as saving data, saving own private state before process stops. The process stops 310, indicating the connection is stopped or the session is disconnected.

The method call stop sequence of TS 108 includes stopping all of the listeners for the protocol providers and all incoming connections by disconnecting the sessions. The terms such as, disconnect, stops, and shutdowns, are used interchangeably to indicate the computing device 104 is no longer connected to the server 110 or the session is disconnected from TS 108. The dashed lines illustrate that the TS 108 stops responding and stops servicing remote procedure call requests (RPC). In an exemplary implementation, the shutdown phase may take less than ten seconds.

Block 310 illustrates TS 108 calling WSXStartSave. The windows APIs 224 call the extension components 226, once the remote connection manager 218 is stopping and allow the extension components, WSX 226 to save and to update any global state or session information, hContext packed in a contiguous serialized format. Alternatively, the session information may be packed in non-contiguous serialized format. This session information includes saving a portion to evaluate the reconnection policy of the session. For every session information in the hContext list, TS 108 calls WSX save such as in hContext and in SLUID, and TS 108 tags a session object in LSM 216 with name of a related WSX DLL.

In an exemplary implementation, the protocol may not need to save any information. The protocol would not include a save API. Thus, TS 108 will not tag the corresponding session object of LSM with any instance of a WSX DLL.

Block 312 illustrates for every stack context, TS 108 calls WSXRundown 312. TS 108 calls WSXRundown in hContext and in SLUID to allow extension components 226 to cache connection specific session information and to cache data pertaining to an associated session of the connection. The extension components 226 employ a caching mechanism which may include a simple file system, another process in the same computer, or a central service residing on a network. Alternatively, the extension components or WSX protocol extensions can implement own caching mechanism and selectively and/or perform lazy restore on saved session information as necessary.

In addition, TS 108 calls WSXRundown 312 to clear all memory used by a stack. Clearing all memory is beneficial as TS 108 may be hosted by shared svchosts, which would not terminate during TS 108 shutdown. Finally, the terminal service stop and a service control manager unloads TS DLL and terminates the svchost process.

Restart or reconnect 314 illustrates reestablishing the session or reconnecting the connection. Prior to restarting, there is an authentication of the client computing device 104. The session information saved, such as the reconnection policy of the session, hContext, SLUID, connection specific session information, and data pertaining to the associated session of the connection all provide assistance in reconnecting the session 314. In an exemplary implementation, there is an auto reconnect cookie. As part of the reconnection, TS 108 and WSX protocol extensions form a handshake for WSX protocol extensions to copy or merge hContext data from a target disconnected session to a new active stack.

Shown is the word document to illustrate the data is not lost during shutdown and restart in TS. The extension components 226 help save session information for the connection and data of the user 102. Thus, once the service is restarted, users on the remote terminal sessions may continue working on the application, which is not lost during the shutdown and restart.

### Sequence of Method Calls

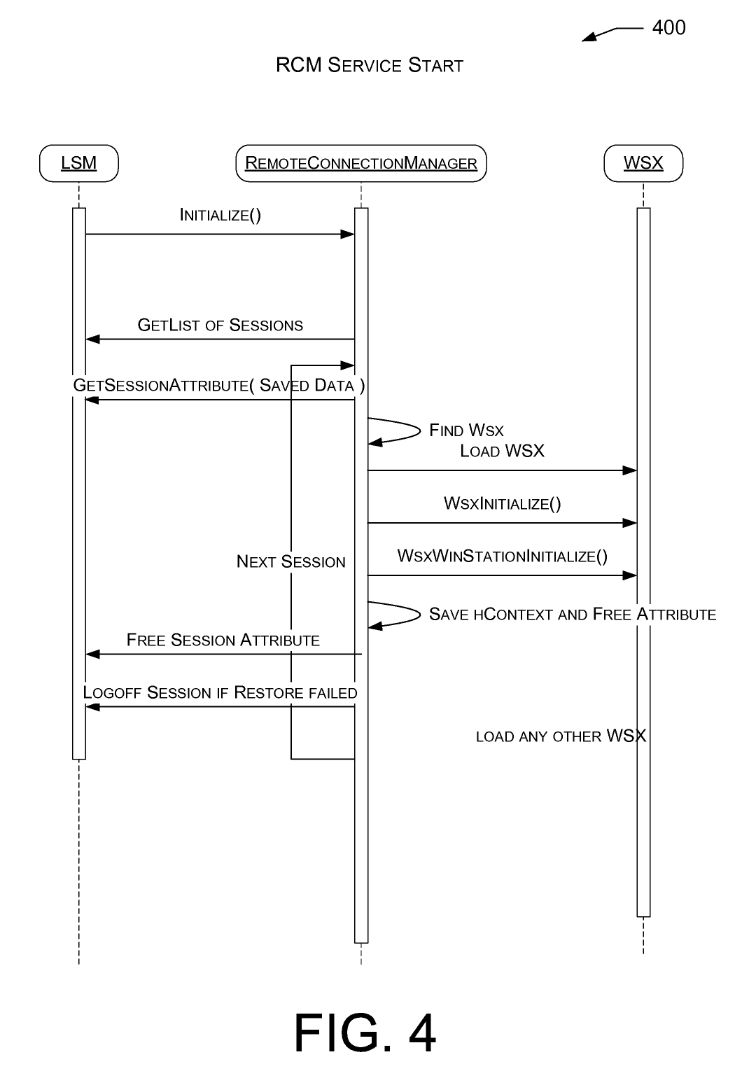

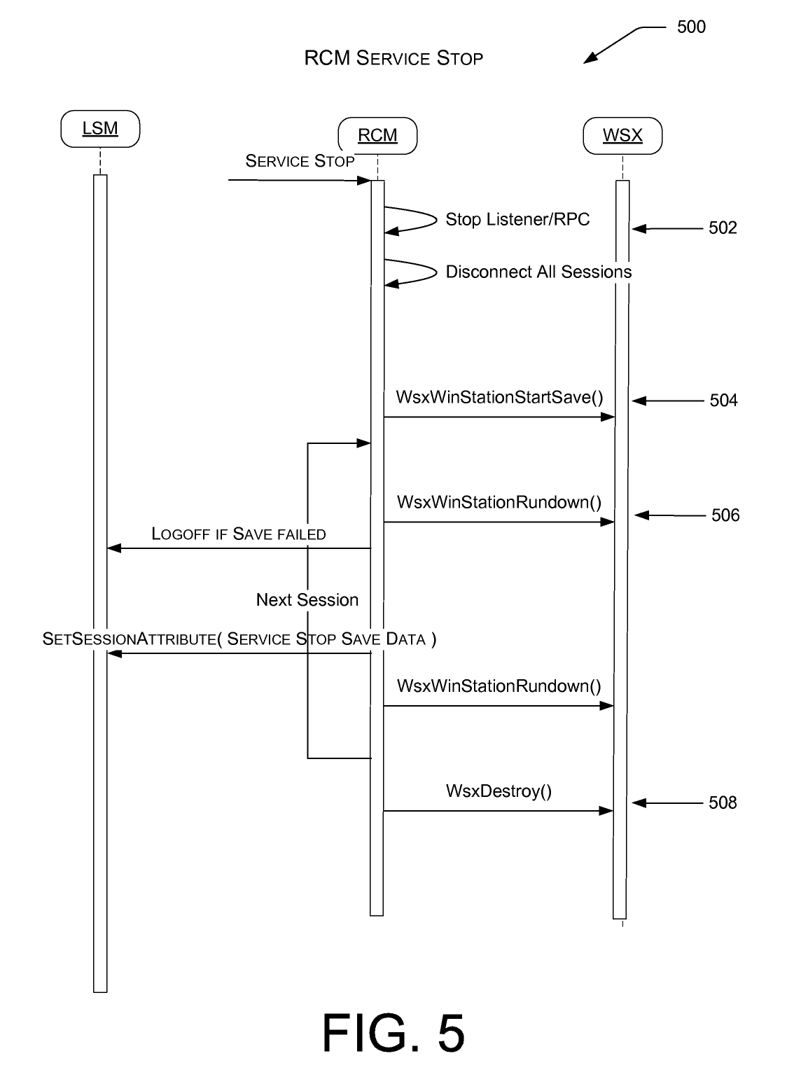

FIGS. 4 and 5 illustrate exemplary manner of operation of sequence of method calls for the system 200. FIG. 4 illustrates an exemplary sequence of method calls for a remote connection manager service start 400 and FIG. 5 illustrates an exemplary sequence of method calls for a remote connection manager service stop 500. The sequence of method calls illustrate the signing on through LSM in both figures.

In FIG. 4, illustrates an exemplary sequence of method calls to start the remote connection manager (RCM) algorithm. Starting on the left side of the flowchart, the APIs of the LSM 216 makes a call to the RCM 218 to initialize TS 108. This is performed by calling an Initialize( ) method, not to be confused with Start( ).

Shown in WSXInitialize( ), to initialize, the RCM begins information exchange with the LSM by retrieving a list of sessions, and GetSessionAttribute (Saved Data).

Shown next, the RCM retrieves SLUID and any matching WSX, loading and initializing, if not already completed. For example, the RCM may retrieve or find any stored extension DLL, WSX. Save hContext and free attribute are two functions that are performed. The APIs cache and restore hContext, free attribute information along with the session. The RCM may logoff the session if the restore failed.

Moving further down, the RCM may take similar action on other protocol extension providers. In particular, the RCM loads other individual protocol extensions.

FIG. 5 illustrates an exemplary sequence of method calls for change of state, such as running and stopping the RCM. As shown in the upper left side of the diagram, the LSM makes a call to the RCM of a service stop. Shown in 502, the RCM stops listeners for the extension component providers, stops servicing RPC requests, and disconnects all sessions. As a result, the RCM disconnects all connections and stops all incoming connections.

Shown at 504, the APIs of RCM make calls using WsxWinStationStartSave( ) to signal RCM is about to change state from running to stopping. The extension components take action such as saving and updating any global state, data, or session information.

Shown at 506, the APIs of RCM make calls using WsxWinStationRundown( ) to signal the process is about to shut down. The extension components take appropriate action, such as cache connection specific session information and associated session of the connection. The API call returns a parameter or error code as to whether the above occurred. If the save failed, the session may logoff. This occurs for every stack content in TS. Next, TS 108 tags and stores the extension components, WSX DLL, and pushes information to the LSM.

Shown at 508, the APIs of RCM make calls using WsxDestroy( ) to clear all memory used by the stacks. This is beneficial if TS 108 was hosted by shared svchosts, where the svchost would not terminate during TS shutdown.

### Exemplary Processing Functionality

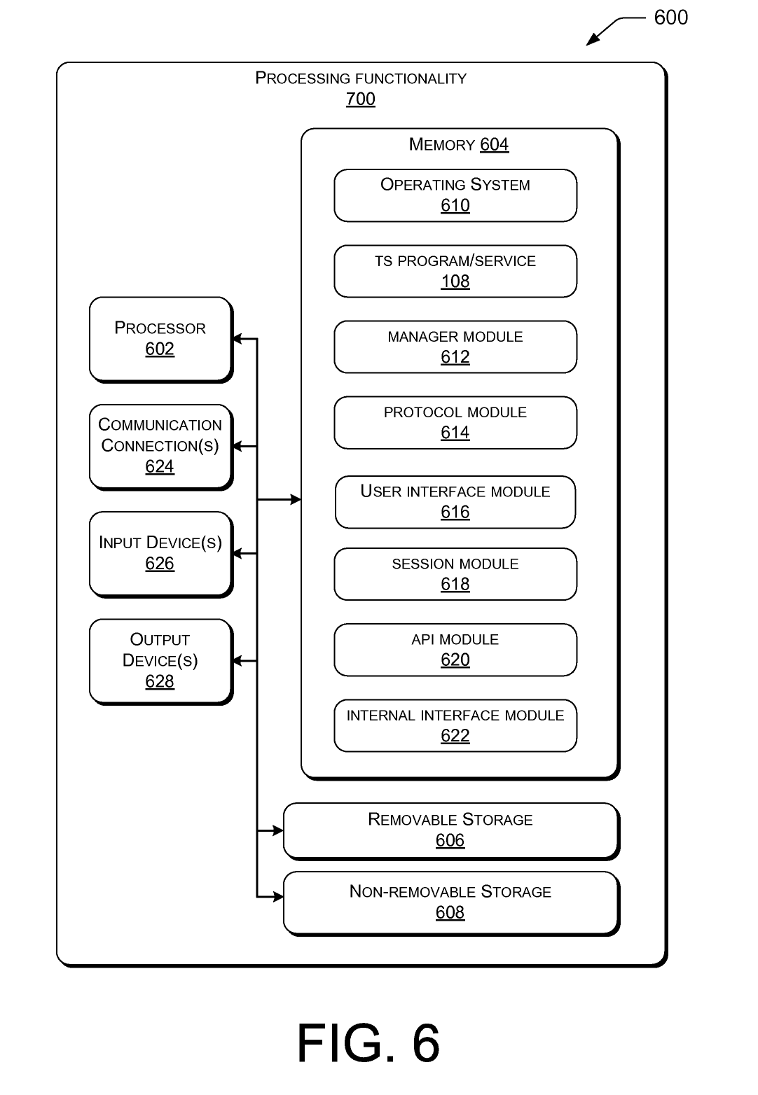

FIG. 6 illustrates an exemplary processing functionality 600, that may be located in the computing devices 104 of the user 102 or the remote host computer 110 of the system 200 of FIG. 2. The processing functionality 600 may be configured as any suitable computing device or server capable of implementing TS 108. In one exemplary configuration, the processing functionality 600 comprises at least one processing unit 602 and memory 604. The processing unit 602 may be implemented as appropriate in hardware, software, firmware, or combinations thereof. Software or firmware implementations of the processing unit 602 may include computer- or machine-executable instructions written in any suitable programming language to perform the various functions described.

Memory 604 may store programs of instructions that are loadable and executable on the processor 602, as well as data generated during the execution of these programs. Depending on the configuration and type of computing device, memory 604 may be volatile (such as RAM) and/or non-volatile (such as ROM, flash memory, etc.). The terminal server 110(a) may also include additional removable storage 606 and/or non-removable storage 608 including, but not limited to, magnetic storage, optical disks, and/or tape storage. The disk drives and their associated computer-readable media may provide non-volatile storage of computer readable instructions, data structures, program modules, and other data for the computing devices.

Memory 604, removable storage 606, and non-removable storage 608 are all examples of computer storage media. Computer storage media includes volatile and non-volatile, removable and non-removable media implemented in any method or technology for storage of information such as computer readable instructions, data structures, program modules or other data. Memory 604, removable storage 606, and non-removable storage 608 are all examples of computer storage media. Additional types of computer storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the terminal server 110(a) or other computing device.

Turning to the contents of the memory 604 in more detail, may include an operating system 610, one or more application programs or service for implementing TS 108. In one implementation, the memory 604 includes a manager module 612 and a protocol management module 614. The manager module 612 includes but is not limited to identifying and tracking a session. The protocol management module 614 stores and manages storage of information, such as session identifier, session state, computing devices of the user, and the like, and may communicate with one or more local and/or remote databases or services.

The memory 604 further includes a user interface module 616 and a session module 618. The user interface module 616 presents the user with the user interface to log in or log off TS program, in and out of a session, and the like. The session module 618 includes but is not limited to, tracking a state of the computing devices 104, logging in or logging off TS, connecting or disconnecting from TS, and the like. The session module 618 performs connections, disconnections, search functions, such as performing searches to identify the client devices that are logged on, logged off, state of the client devices, the status of the user 102, and the like.

The memory 604 may include application programming interface (APIs) module 620 and an internal interface module 622. The APIs 620 help support requests for services made by TS.

The processing functionality 600 may also contain communications connection(s) 624 that allow the processing functionality 600 to communicate with a stored database, another computing device or server, the user terminals, and/or other devices on the network 106. Communications connection(s) 624 is an example of communication media. Communication media typically embodies computer readable instructions, data structures, and program modules. By way of example, and not limitation, communication media includes wired media such as a wired network or direct-wired connection, and wireless media such as acoustic, RF, infrared and other wireless media. The term computer readable media as used herein includes both storage media and communication media.

The processing functionality 600 may also include input device(s) 626 such as a keyboard, mouse, pen, voice input device, touch input device, etc., and output device(s) 628, such as a display, speakers, printer, etc. The processing functionality 600 may include a database hosted on the processing functionality 600 including, but is not limited to, session data, network addresses, list of computing devices 104, and the like. All these devices are well known in the art and need not be discussed at length here.

The subject matter described above can be implemented in hardware, or software, or in both hardware and software. Although the subject matter has been described in language specific to structural features and/or methodological acts, it is to be understood that the subject matter defined in the appended claims is not necessarily limited to the specific features or acts described above. Rather, the specific features and acts are disclosed as exemplary forms of implementing the claimed subject matter. For example, the methodological acts need not be performed in the order or combinations described herein, and may be performed in any combination of one or more acts.

1. A method for synchronization, implemented at least in part by a computing device, the method comprising:
starting a remote terminal session for a computing device, wherein the computing device has a session local unique identifier;
retrieving the session local unique identifier and a matching extension component name; and
loading and initializing extension components;
wherein the extension components provide for,
saving session information for the session when the remote terminal session is disconnected; and
restoring the session information when the remote terminal session is reconnected for the computing device.

2. The method of claim 1, wherein the session information comprises a configuration to reconnect or to restart the session.

3. The method of claim 1, wherein the session information for the session comprises a contiguous serialized format.

4. The method of claim 1, wherein the restoring session information comprises unpacking a serialized format into memory space of a terminal service.

5. The method of claim 1, wherein the restoring session information comprises deserializing the session information.

6. The method of claim 1, further comprising copying the session information from a disconnected session to a new active stack.

7. The method of claim 1, further comprising caching session specific session information and associated session of a connection.

8. The method of claim 1, further comprising maintaining application data on the computing device for an application connected through the remote terminal session, wherein the application data is not lost during restarting and/or disconnecting the session.

9. The method of claim 1, further comprising tagging a session object with a name of a related winstation extension dynamically linked library.

10. The method of claim 1, further comprising calling to clear memory space used by a stack.

11. The method of claim 1, further comprising extension components store or retrieve session information from own storage service.

12. One or more computer-readable storage media comprising computer-executable instructions that, when executed, perform the method as recited in claim 1.

13. A system for synchronization, the system comprising:
a processor;
a memory coupled to the processor;
wherein the processor is configured for synchronizing session information between a remote connection manager and extension components during service stops and starts by:
establishing a connection for a session for a computing device on a terminal service, wherein the connection has a session local unique identifier;
issuing a notification when the terminal service is able to stop;
enabling the extension components to save session information of a connection stop or a session disconnect on the terminal service when the connection stops or the session disconnects; and
restoring session information for the connection on restarts.

14. The system of claim 13, further comprising a user interface issuing a notification for an approaching disconnection on an active computing device.

14. The system of claim 13, further comprising an internal interface enabling a remote connection manager to cache data onto a session object.

15. The system of claim 13, further comprising application program interfaces to serialize and to deserialize session information.

16. The system of claim 13, further comprising at least one of a cache mechanism, a storage, or a storage service for the extension components.

17. The system of claim 13, further comprising maintaining data from a service or an application prior to the terminal service stop by not losing any data on the one or more computing devices upon restarting the terminal service.

18. An application programming interface having computer-readable instructions that, when executed by a processor, cause the processor to perform acts comprising:
notifying extension components of session disconnections;
enabling the extension components to save session information for a session upon the session disconnecting, wherein the session information includes a configuration to reconnect the session;
enabling the extension components to restore session information on reconnecting the session; and
serializing and deserializing the session information.

19. The application programming interface of claim 18, further comprising instructions to cause the processor to perform acts comprising caching data onto a session object.

20. The application programming interface of claim 18, further comprising instructions to cause the processor to perform acts comprising saving and storing the session information on own storage or service.
